(19) United States
(12) Patent Application Publication
(10) Pub. No.: US 2024/0313234 A1
(43) Pub. Date: Sep. 19, 2024

(54) METHOD AND DEVICE FOR PRODUCING A MEMBRANE-ELECTRODE ASSEMBLY

(71) Applicant: MB ATECH GmbH, Roding (DE)

(72) Inventors: Sven Hochmann, Dresden (DE); Stefan Mueller, Dresden (DE); Joerg Leibiger, Freital (DE)

(21) Appl. No.: 18/575,415

(22) PCT Filed: Jun. 24, 2022
(86) PCT No.: PCT/EP2022/067336

§ 371 Date: Dec. 29, 2023

(30) Foreign Application Priority Data
Jul. 2, 2021 (DE) 10 2021 117 083.4

(51) Int. Cl. H01M 8/0273; B32B 37/00; B65G 21/20; H01M 4/88; H01M 8/1004

(52) U.S. Cl. CPC H01M 8/0273; B32B 37/0053; B65G 21/2036; H01M 4/8807; H01M 8/1004; B32B 2457/18

(57) ABSTRACT

A method of manufacturing a membrane electrode assembly, MEA, comprises the steps of:
continuous conveying, with a first vacuum conveyor belt, a first MEA component in the form of a web material at a first conveying speed;
at least partially arranging, with a first arranging device, a second MEA component on the first MEA component while the first MEA component is continuously conveyed by the first vacuum conveyor belt;
cutting, with a first cutting device, the first MEA component provided as web material with the second MEA component at least partially arranged thereon into a plurality of MEA component sections, so that the MEA component sections each comprise at least a part of the first and the second MEA component; and
continuously conveying, with a second vacuum conveyor belt, the plurality of MEA component sections at a second conveying speed.

### CROSS-REFERENCE TO RELATED APPLICATIONS

This application is a National Stage application of International Application No. PCT/EP2022/067336 filed Jun. 24, 2022, which claims priority to German Patent Application Serial No. DE 102021117083.4 filed Jul. 7, 2021.

### BACKGROUND

### Field

A method and a device for manufacturing a membrane electrode arrangement, for example a membrane electrode arrangement for a fuel cell, are described here.

### Discussion of the Related Art

A well-known method for manufacturing a membrane electrode assembly for a fuel cell is the so-called pick-and-place method. Here, robots or grippers arranged on rails are used, which can perform movements in different spatial directions in order to place the different components of the respective membrane electrode assembly with the required accuracy. Such a pick-and-place method for manufacturing membrane electrode assemblies and fuel cells in large-scale production is demanding in terms of material costs and also due to the necessary handling of the filigree and dirt-sensitive components.

It is also known to provide a support for a membrane and/or an electrode as part of a continuous web of material. Alternatively, a membrane and/or an electrode can also be provided as a material web. In this case, the material web can pass through a plurality of processing stations, whereby at least a second component of the membrane-electrode arrangement is connected to the material web. Such a method is disclosed, for example, in document DE 10 2015 010 440 A1.

Further membrane electrode arrangements and associated manufacturing processes are known from the documents DE 10 2010 049 548 A1, DE 10 2010 054 199 A1, WO 2021/089 093 A1, US 2016/0 141 642 A1, DE 10 2016 001 817 A1, US 2016/0 111 734 A1, KR 10 2016 0 131 748 A and DE 10 2011 105 180 A1.

A disadvantage of known manufacturing methods for membrane electrode arrangements with at least initially continuous material webs is that the material webs are very thin and therefore very sensitive. Therefore, no or only a low tensile force can be exerted on the material webs without damaging them. The material webs can therefore not or only insufficiently be stretched or fixed, which has a negative impact on production accuracy. It is therefore desirable to improve the fixation of the material webs, particularly when arranging the components for a membrane electrode arrangement next to or on top of one another.

A further disadvantage of known manufacturing processes for membrane electrode assemblies with at least initially continuous material webs is that a distance between material web or component sections isolated or separated from each other in a process step cannot be changed without interrupting production. In other words, a component provided as a material web can be separated into several sections, but these component sections are then positioned directly adjacent to each other, so that it is not possible to arrange further, in particular larger, components on the separated component sections. It is therefore desirable to be able to change the distance between individual or separated material web or component sections without interrupting a continuous production process.

There is therefore a need for an improved manufacturing method and an improved manufacturing device for manufacturing a membrane-electrode arrangement, which in particular improve the arrangement of the components for the membrane-electrode arrangement next to or on top of one another.

### SUMMARY

A method of manufacturing a membrane electrode assembly, MEA, comprises at least the steps of:
Providing at least one carrier web;
Conveying the carrier web along a conveyor path;
Conveying an air-permeable or gas-permeable support web with at least one vacuum drum, wherein one or more MEA component sections are arranged on the conveyed air-permeable support web;
Arranging one or more MEA component sections on the carrier web, the MEA component sections being arranged on the carrier web with a surface facing away from the air-permeable support web in each case; and
Detachment of the air-permeable support web from the MEA component sections arranged on the carrier sheeting.

Optionally, the method of manufacturing the MEA may further comprise one of the following steps:
Providing the air-permeable support web;
Arrangement of one or more MEA component sections or an MEA component on the air-permeable support web, wherein the MEA component sections or the MEA component are fixed at least temporarily by the vacuum drum, in particular by means of a vacuum on the support web.

One advantage of this method is that the MEA component sections and/or the MEA component can be conveyed on the support web without tension. Tension forces occurring during conveying and/or tension forces caused by conveying can be absorbed or compensated for by the support web. No or hardly any (tensile or clamping) forces act on the MEA component and/or the MEA component sections themselves during conveying, in particular no or hardly any (tensile or clamping) forces in the conveying direction of the MEA component and/or the MEA component sections and the support web. Damage to the MEA component and/or the MEA component sections can thus be counteracted.

The MEA component can, for example, comprise a membrane, in particular one coated with a catalyst, or a gas diffusion layer. This membrane and/or this gas diffusion layer can each have a thickness of 5 μm to 25 μm, in particular a thickness of 5 μm to 8 μm. One advantage of using a support web is that these thin MEA components can be handled reliably and/or without damage.

A further advantage of this method is that contamination of the vacuum drum and/or other conveyor elements can be counteracted by an adhesive that is optionally applied to the MEA component sections or to the support web. The support web can be wider than the MEA component and/or the MEA component sections and/or have a larger surface area than the MEA component. In particular, the support web can protrude beyond the MEA component and/or MEA component sections arranged on it in a direction transverse to the conveying direction and/or protrude beyond the MEA component or beyond the MEA component sections in a direction transverse to the conveying direction. The adhesive applied to the MEA component or the MEA component sections can therefore be picked up by the support web and/or transported away with the support web, for example in the event of unintentional smearing or in the event of incorrect application of the adhesive.

A vacuum drum is a conveyor drum or a conveyor cylinder that is suitable for conveying a material web, for example a support web or an MEA component, and/or one or more individual MEA component sections, in particular without slippage. The vacuum drum is designed to fix the material web or the material web sections to a drum or cylinder shell surface by means of a vacuum. The vacuum can, for example, act on the support web and/or on the MEA component sections and/or the MEA component arranged on the support web by means of openings in the drum or cylinder shell surface and fix them to the drum or cylinder shell surface.

The openings in the drum or cylinder shell surface and/or the vacuum acting through these openings can be selectively activated or deactivated by a control system and/or controlled or regulated depending on a rotation of the vacuum drum and/or depending on predetermined time intervals.

Optionally, the detachment of the air-permeable support web from the MEA component section arranged on the carrier web can comprise the removal of the negative pressure. In other words, the lifting or controlled compensation of a negative pressure acting on the carrier web and/or on the MEA component section can remove a fixation of the support web and the MEA component section to each other and to the drum or cylinder shell surface of the vacuum drum. Furthermore, the vacuum drum can be arranged and designed to press or roll the MEA component section against the carrier web during arrangement on the carrier web.

The arrangement of the MEA component section on the carrier web can comprise a material bonding thermal joining method, in particular a lamination method, or a cold lamination method which fixes the MEA component section on the carrier web. Optionally, a separate lamination device and/or a separate heating device can be provided for this purpose. A pressing device, in particular a separate pressing device, which is designed and arranged to press the carrier web and an MEA component section against each other, can also be provided. Alternatively or additionally, an MEA component section can also be pressed or rolled onto the carrier web and/or the carrier frames with/through the vacuum drum. One advantage here is that any excess adhesive that may escape during the pressing or rolling of the MEA component section onto the carrier web and/or the carrier frames can be absorbed and/or transported away by the support web and, in particular, contamination or soiling of the vacuum drum can be avoided.

The method may further comprise applying an adhesive, for example with an adhesive application device, to the carrier web conveyed along the conveying path. Alternatively or additionally, an adhesive can also be applied or applied to the MEA component and/or to one or more MEA component sections, for example using an adhesive application device.

The support web can be provided as a continuous web material, in particular from a support web roller. In other words, the support web can be provided as a quasi-infinite continuous web material. The support web may have segmentations or a uniform surface structure. The support web may comprise a textile material and/or a plastic material. In one variant, the support web can have a (plastic) fabric structure. The support web may have a greater thickness and/or a greater/higher tensile strength than the first or second MEA component.

Optionally, the support web can have several recesses or perforations that make the support web permeable to air. In other variants, the support web can alternatively or additionally have an air-permeable fabric structure and/or an air-permeable plastic membrane.

The carrier web can comprise or form one or more carrier frames for an MEA. In particular, the carrier web may be provided as a continuous web material, for example as a quasi-infinite web material, from a carrier web roll. In other words, the carrier web can have several carrier frames that can be separated or separated from one another in a production step, for example by cutting the carrier web.

Optionally, one or more recesses or openings can be made in the carrier frame(s), in particular using a punching device and/or a milling device.

Optionally, the method of manufacturing the MEA may further comprise the following step:
Production of several MEA component sections by cutting the MEA component provided as continuous web material with a cutting device, in particular with a cutting cylinder.

In particular, a cutting cylinder may be a cutting roller or other rotating cutting device suitable for cutting or separating an MEA component provided as continuous web material into a plurality of MEA component sections. However, in other embodiments, other cutting or slicing devices may also be used for cutting or separating an MEA component provided as continuous web material into a plurality of MEA component sections, expressly including those that do not have rotating (cutting) elements.

The MEA component can comprise a gas diffusion layer, GDL, in particular an anode or a cathode in the form of a GDL. Furthermore, the MEA component can comprise a membrane, CCM, in particular one coated with a catalyst. The MEA component can, for example, be provided as a continuous web material, in particular from a GDL or CCM roll.

In one embodiment, the cutting of an MEA component provided as a continuous web material can take place while the MEA component is arranged on the air-permeable support web. The air-permeable support web does not have to be severed by cutting the MEA component.

In other words, the cutting device can be configured to cut or sever an MEA component fixed by the vacuum drum and/or arranged on the vacuum drum, in particular with the support web. For example, several MEA component sections can be produced in this way, which are fixed by the vacuum drum and/or arranged on the vacuum drum, in particular on the support web fixed by the vacuum drum. The support web can remain uncut or uncut. The cutting device can be configured to cut the MEA component provided as continuous web material without cutting the support web, whereby the MEA component is arranged on the support web during cutting.

One advantage here is that the MEA component can be cut, for example, with a cutting cylinder, whereby the air-permeable support web can, on the one hand, ensure or at least promote the desired unchanged positioning of the component sections produced in this way on/on the shell surface of the vacuum drum and, on the other hand, protect the vacuum drum from direct contact with the cutting tools/blades of the cutting device. In other words, the support web can be arranged between the MEA component and the drum or cylinder shell surface of the vacuum drum. This can prevent direct contact of the shell surface with the cutting tools/blades of the cutting device and at the same time ensure or at least promote the complete severing or cutting through of the MEA component.

An apparatus for manufacturing a membrane electrode assembly comprises:
(i) a carrier web providing device adapted to provide at least one carrier web for a membrane electrode assembly;
(ii) a conveying device which is configured to convey the at least one carrier web continuously or cyclically along a conveying path;
(iii) a vacuum drum adapted to convey an air-permeable support web, wherein one or more MEA component sections are disposed on the conveyed air-permeable support web; and
(iv) an arranging device which is configured to arrange at least one MEA component section with a surface facing away from the air-permeable support web on the carrier web, wherein the device for producing a membrane electrode arrangement is also configured to detach the air-permeable support web from the MEA component section arranged on the carrier web.

The carrier web supply device can in particular be a carrier web roller which is configured to supply the carrier web as a continuous web material, for example as a quasi-infinite web material. The carrier web can have several carrier frames, which can be separated or separated from each other by a separating or cutting device, for example by cutting the carrier web.

The conveying device can be a vacuum conveyor belt, in particular a circulating one, which is configured to continuously convey a carrier web and/or to fix/hold it in place during conveying by means of a vacuum. The conveying device can convey a carrier web, in particular without tension. Tension-free means that no (tensile) force is exerted on the web material or the carrier web in the conveying direction during the conveying of a web material, in particular the carrier web. In other words, tension-free means that the web material has no or hardly any material tension in a direction parallel to the conveying direction caused by the conveying.

The arranging device can be a separate device, for example a lamination device and/or a heating device, which is configured to carry out a material-bonding thermal joining method and/or a cold lamination method. In one variant, the vacuum drum can also form the arranging device and/or at least part of the arranging device. By deactivating or releasing the vacuum, an MEA component or an MEA component section can be detached from the support web, whereby the vacuum drum can simultaneously be arranged and designed to press or roll the detached MEA component or the detached MEA component section onto the support web during arrangement on the support web.

A method of manufacturing a membrane electrode assembly, MEA, comprises at least the steps of:
Providing at least a first MEA component as continuous web material;
Conveying the first MEA component along a conveyor path;
Provision of a second MEA component in the form of a continuous web material;
Conveying the second MEA component with at least a first vacuum drum;
Production of several MEA component sections by cutting the second MEA component provided as continuous web material with a cutting device;
Arrange the MEA component sections on the first MEA component.

The second MEA component, which is provided as a continuous web material, lies against a lateral surface of the first vacuum drum during cutting into the multiple MEA component sections and is conveyed continuously and without slippage.

An advantage here is that the MEA component is fixed by the first vacuum drum during cutting into a plurality of MEA component sections, so that positioning of the MEA component and/or MEA component sections can be maintained during and/or after cutting. The use of a vacuum drum in combination with a cutting device, in particular with a cutting cylinder, makes it possible to specify and/or maintain the positioning of the MEA component sections for further production with high precision.

A vacuum drum is a conveyor drum or a conveyor cylinder which is suitable for conveying a material web, for example an MEA component provided as web material, and/or one or more individual material web sections, in particular without slippage, whereby the vacuum drum is configured to fix the material web or the material web sections to a drum or cylinder shell surface by means of a vacuum. The vacuum can, for example, act on the support web and/or on the MEA component arranged on the support web by means of openings in the drum or cylinder shell surface and fix it to the drum or cylinder shell surface.

The cutting device can in particular be a cutting cylinder. In particular, a cutting cylinder may be a cutting roller or other rotating cutting device suitable for cutting or separating an MEA component provided as continuous web material, for example the second MEA component, into a plurality of MEA component sections. However, in other embodiments, any other separating or cutting devices can also be used for cutting or separating an MEA component provided as continuous web material into a plurality of MEA component sections, expressly including those that do not have rotating (cutting) elements.

In particular, the cutting device can be configured to cut the second MEA component into several component sections, while the second MEA component is fixed to a drum or cylinder shell surface of the first vacuum drum by means of negative pressure. The component sections produced by cutting up the second MEA component can also be fixed to a drum or cylinder shell surface of the first vacuum drum by means of negative pressure. The first vacuum drum can be configured to detach or release the component sections by lifting or deactivating the negative pressure. In other words, by lifting or controlled compensation of a negative pressure acting on the component sections, a fixation of the component sections on the drum or cylinder shell surface of the first vacuum drum can be removed. The component sections can then be arranged and/or fixed on the first MEA component or on/at the drum or cylinder shell surface of a further or second vacuum drum.

A conveying path is a predetermined path along which MEA components and/or MEA component sections are conveyed in a predetermined conveying direction. In other words, the conveying path is the path that the MEA components and/or MEA component sections travel during the production of the MEA. The conveying path and/or the conveying direction can, for example, be predetermined and/or defined by a conveyor belt, in particular a circulating conveyor belt.

The arrangement of the MEA component sections on the first MEA component can comprise a materially bonding thermal joining method, in particular a lamination method and/or a cold lamination method, which fixes the MEA component sections on the first MEA component. Optionally, a separate lamination device and/or a separate heating device can be provided for this purpose. A pressing device, in particular a separate pressing device, which is designed and arranged to press MEA components against each other or onto each other, may also be provided. Furthermore, the method can comprise the application of an adhesive, for example with an adhesive application device, to the first MEA component conveyed along the conveying path and/or to the MEA component sections.

The first MEA component can comprise a carrier web provided as a continuous, in particular quasi-infinite, web material. The carrier web may comprise or form one or more carrier frames for an MEA. In particular, the carrier web may be provided as a continuous web material, for example as a quasi-infinite web material from a carrier web roll. In other words, the carrier web can have several carrier frames that can be separated or separated from each other in one production step, for example by cutting the carrier web.

The first and/or the second MEA component can comprise a gas diffusion layer, GDL, in particular an anode or a cathode in the form of a GDL. Furthermore, the first and/or the second MEA component may comprise a membrane, CCM, in particular one coated with a catalyst. The first and/or the second MEA component can be provided, for example, as a continuous web material, in particular from a GDL or CCM roll. The second MEA component can have several MEA component sections, which can be separated or separated from each other in a manufacturing step, for example by cutting the second MEA component.

In one variant, the second MEA component can be conveyed without a tensioning force acting on the material of the second MEA component in the conveying direction. In particular, the second MEA component can be conveyed to the first vacuum drum without tension. Tension-free means that during the conveying of a web material, in particular the second MEA component, no (tensile) force is exerted on the web material in the conveying direction. In other words, tension-free means that the web material has no or hardly any material tension in a direction parallel to the conveying direction caused by the conveying.

Conveying the second MEA component without a clamping force acting on the material of the second MEA component in the conveying direction can be achieved, for example, by a coordinated or controlled angular speed of the first vacuum drum and a GDL or CCM roller, which can provide the second MEA component, for example.

Optionally, the method of manufacturing the MEA may further comprise the following step:
Arrangement of the MEA component sections on at least one further vacuum drum and slip-free conveying of the MEA component sections with the further or second vacuum drum, wherein the at least one further or second vacuum drum has a jacket surface with an adhesion-reducing coating, in particular with a Teflon coating.

In other words, the component sections can be transferred or passed from the first vacuum drum to the further vacuum drum. Subsequently, the component sections can be continuously conveyed by the further vacuum drum and/or arranged on the first MEA component while it is conveyed along the conveying path.

An advantage here is that the MEA component sections can be pressed or rolled onto the first MEA component, for example onto the carrier web and/or the carrier frame, with/through the further vacuum drum with the adhesion-reducing coating. The further vacuum drum can form an arranging device or part of an arranging device which is configured to arrange the MEA component sections on the first MEA component. The advantage of this is that the MEA component sections can be detached from the additional vacuum drum particularly well due to the adhesion-reducing coating and incorrect positioning of the MEA component sections due to adhesion or irregular detachment of the MEA component sections from the vacuum drum can be avoided. This can improve both production precision and production speed.

The use of a further or second vacuum drum with an adhesion-reducing coating is also advantageous because the adhesion-reducing coating, in particular a Teflon coating, is sensitive to possible contact with the blades or cutting tools of the cutting device. Since a complete severing or cutting of the second MEA component is necessary to produce the MEA component sections, an at least partial contact of the blades or cutting tools with the surface of the vacuum drum cannot be excluded if the second MEA component rests against a jacket surface/surface of a vacuum drum during the cutting into the multiple MEA component sections and is continuously conveyed. It is therefore advantageous to perform the cutting of the second MEA component while it is being conveyed by a first vacuum drum and to perform the arrangement of the MEA component sections on the first MEA component with a further or second vacuum drum which has an adhesion-reducing coating on its jacket surface. The shell surface of the first vacuum drum may, in contrast to the shell surface of the further or second vacuum drum, have a coating that is insensitive or tolerant to contact with the blades or cutting tools of the cutting device. For example, the first vacuum drum can have a rubber or plastic coating on its outer surface and/or be at least partially made of a rubber or plastic material. The transfer or arrangement of the component sections from the first vacuum drum to/on the further or second vacuum drum is less demanding than the arrangement of the MEA component sections on the first MEA component, since the second vacuum drum can actively suck in the respective MEA component sections with/through a vacuum and can thus at least support a detachment of the MEA component sections from the first vacuum drum.

An apparatus for manufacturing a membrane electrode assembly, MEA, comprises:
(i) a provisioning device adapted to provide a first MEA component in the form of a continuous web material for a membrane electrode assembly;
(ii) a conveying device which is configured to convey the first MEA component continuously or cyclically along a conveying path;
(iii) a first vacuum drum adapted to convey a second MEA component in the form of a continuous web material continuously and without slippage,
(iv) a cutting device adapted to cut the second MEA component provided as a continuous web material into a plurality of MEA component sections while the second MEA component provided as a continuous web material abuts against a peripheral surface of the vacuum drum, and
(v) an arranging device adapted to arrange the MEA component sections on the first MEA component.

The supply device can in particular be a carrier web roller which is configured to supply a carrier web as a continuous web material, for example as a quasi-infinite web material. The carrier web can have several carrier frames, which can be separated or separated from each other by a separating or cutting device, for example by cutting the carrier web.

The conveying device can be a vacuum conveyor belt, in particular a circulating one, which is configured to continuously convey a first MEA component, in particular a carrier web, and/or to fix/hold it in place during conveying by means of a vacuum. The conveying device can convey the first MEA component, in particular without tension. Tension-free means that during the conveying of a web material, in particular the carrier web, no (tensile) force is exerted on the web material/carrier web in the conveying direction. In other words, tension-free means that the web material has no or hardly any material tension in a direction parallel to the conveying direction caused by the conveying process.

The arranging device can be a separate device, for example a lamination device and/or a heating device, which is configured to carry out a material-bonding thermal joining method and/or a cold lamination method. In one variant, a vacuum drum can form the arranging device and/or at least part of the arranging device. By deactivating or releasing the vacuum, an MEA component section can be detached from the vacuum drum, whereby the latter can simultaneously be arranged and designed to arrange the detached MEA component section on the first MEA component during the arrangement.

The first vacuum drum can have a jacket surface that is coated with a rubber or plastic material and/or is at least partially made of a rubber or plastic material.

Optionally, this device can also comprise at least one further or second vacuum drum, which is configured to receive or take over the MEA component sections from the first vacuum drum and then convey them without slippage, wherein the at least one further or second vacuum drum can have a jacket surface with an adhesion-reducing coating, in particular with a Teflon coating.

An apparatus for manufacturing a membrane electrode assembly, MEA, may comprise a first vacuum conveyor belt adapted to continuously convey a first MEA component in the form of a web material at a first conveying speed. A first arranging device may be adapted to arrange a second MEA component and/or an MEA component portion of the second MEA component at least partially on the first MEA component while the first MEA component is continuously conveyed by the first vacuum conveyor belt. A first cutting device can be configured to cut the first MEA component provided as web material with the second MEA component arranged at least partially thereon into a plurality of MEA component sections, each comprising at least a part of the first and second MEA components.

It is also possible here that between the several MEA component sections, each comprising at least a part of the first and the second MEA component, scrap sections are also produced or manufactured which are not MEA component sections and are not intended for the further manufacture of an MEA. In other words, two MEA component sections produced by cutting do not necessarily have to be adjacent to each other on the first vacuum conveyor belt, since a scrap section can also be arranged on the vacuum conveyor belt between two MEA component sections.

A second vacuum conveyor belt can be configured to convey the multiple MEA component sections continuously at a second conveying speed, the second conveying speed being higher than the first conveying speed.

One advantage here is that the distance between the MEA component sections can be varied, in particular increased, due to the different conveying speeds of the vacuum conveyor belts, while the MEA component sections are conveyed uninterruptedly and/or continuously. Production does not have to be interrupted and/or slowed down to vary or increase the distances between the component sections. Varying or increasing the distances between the component sections using two vacuum conveyor belts is also advantageous because the MEA component sections can be produced on the first vacuum conveyor belt and then further processed on the second vacuum conveyor belt without interrupting production. Varying or increasing the distance between the MEA component sections also makes it possible to carry out processing steps on the MEA component sections that would not be possible with MEA component sections directly adjacent to each other, for example immediately after cutting an MEA component provided as web material.

The first and/or the second vacuum conveyor belt can be configured in particular to convey the first MEA component and/or to fix/hold it during conveying by means of a vacuum. In particular, the vacuum conveyor belt can convey the first MEA component without tension. Tension-free means that no (tensile) force is exerted on the web material in the conveying direction during the conveying of a web material, in particular the first MEA component. In other words, tension-free means that the web material has no or hardly any material tension in a direction parallel to the conveying direction caused by the conveying.

The first cutting device can in particular be a cutting cylinder. In particular, a cutting cylinder may be a cutting roller or other rotating cutting device suitable for cutting or separating an MEA component provided as continuous web material, for example the first MEA component, into a plurality of MEA component sections. However, in other embodiments, other cutting or slicing devices may also be used for cutting or separating an MEA component provided as continuous web material into a plurality of MEA component sections, expressly including those that do not have rotating (cutting) elements.

In one variant, the first MEA component can comprise a gas diffusion layer, GDL, in particular an anode or a cathode in the form of a GDL. The second MEA component can comprise a membrane, CCM, in particular one coated with a catalyst.

The first arranging device can be configured to provide the second MEA component as a continuous web material or as individual material sections, in particular as CCM membrane sections, for arrangement on the first MEA component.

The first arranging device can comprise a vacuum drum. Optionally, a second MEA component originally provided as a continuous, in particular quasi-infinite, web material can be cut into several material sections by a cutting device while it is arranged on a drum or cylinder shell surface of a vacuum drum.

In one embodiment, the apparatus for manufacturing a membrane electrode assembly may further comprise a transfer device adapted to move or transfer the MEA component sections from the first vacuum conveyor belt to the second vacuum conveyor belt. Optionally, the transfer device can comprise a gripper, in particular a vacuum gripper, which is configured to move or transfer the MEA component sections from the first vacuum conveyor belt to the second vacuum conveyor belt. In an alternative embodiment, the first and second vacuum conveyor belts can also be arranged and designed to transfer conveyed component sections from the first vacuum conveyor belt to the second vacuum conveyor belt without an additional transfer device. For this purpose, the first and second vacuum conveyor belts can be arranged directly adjacent to each other or directly next to each other.

A second arranging device can be configured to arrange a third MEA component, in particular a carrier frame for an MEA, on one of the plurality of MEA component sections, while these component sections are continuously conveyed by the second vacuum conveyor belt. The second arranging device can comprise a vacuum drum and/or one or more lamination rollers, which is designed to receive carrier frames, in particular individual carrier frames, to fix them by means of negative pressure, to convey them continuously and then to arrange and/or roll them onto the MEA component sections.

The carrier frame for the MEA can optionally have two or more recesses. The second arranging device can be configured to arrange the carrier frame on one of the plurality of MEA component sections in such a way that the MEA component sections completely cover at least one of the recesses and leave at least one other of the recesses at least partially uncovered.

The third MEA component, which may in particular be a carrier frame, may have a greater spatial extent than the MEA component sections, at least in a longitudinal or conveying direction. In other words, the third MEA component can be larger than the MEA component sections conveyed by the second vacuum conveyor belt, on which the third MEA component is arranged by the second arranging device.

In particular, the second arranging device can be configured to arrange the carrier frame on one of the plurality of MEA component sections in such a way that the carrier frame projects beyond the MEA component sections in a direction parallel to the conveying direction of the second vacuum conveyor belt. In other words, the carrier frame arranged on the MEA component sections can protrude in the conveying direction and/or against the conveying direction.

An advantage here is that the first MEA component does not necessarily have to be the component with the largest longitudinal extension or the longest/largest component. Due to the variation in distance between the component sections, the device makes it possible to arrange a third MEA component on the MEA component sections, which has a larger surface area and/or is longer than the component sections that were previously produced by cutting at least the first MEA component.

Furthermore, the apparatus for producing a membrane electrode assembly may comprise a third arranging device adapted to arrange a fourth MEA component, for example a GDL, in particular an anode or a cathode in the form of a GDL, on one of the plurality of MEA component sections and/or on the third MEA component while it is/they are continuously conveyed by the second vacuum conveyor belt.

Optionally, the device for manufacturing a membrane electrode arrangement may further comprise one or more lamination devices and/or heating devices, each of which is configured to join the MEA components to one another by means of a materially bonding thermal joining method and/or by means of a cold lamination method. A pressing device, in particular a separate pressing device, which is designed and arranged to press the various MEA components against each other or onto each other, can also be provided.

Furthermore, the device may comprise one or more adhesive application devices adapted to apply an adhesive to the MEA components or MEA component sections conveyed by the vacuum conveyor belts. Alternatively or additionally, an adhesive may also be applied to the second, third and/or fourth MEA components by one or more adhesive application devices, in particular before they are respectively applied to the first MEA component and/or the MEA component sections and/or the carrier frames.

Optionally, an inspection device can be arranged and designed to detect a property defect and/or an arrangement defect of the conveyed MEA components and/or MEA component sections. If a property defect and/or an arrangement error is detected, an MEA component or an MEA component section can be excluded from further production, for example by conveying the defective MEA components and/or MEA component sections to a reject receiving or depositing device.

A method of manufacturing a membrane electrode assembly, MEA, comprises at least the steps of:
continuous conveying, with a first vacuum conveyor belt, a first MEA component in the form of a web material at a first conveying speed;
at least partially arranging, with a first arranging device, a second MEA component on the first MEA component while the first MEA component is continuously conveyed by the first vacuum conveyor belt;
cutting, with a first cutting device, the first MEA component provided as web material with the second MEA component at least partially arranged thereon into a plurality of MEA component sections, so that the MEA component sections each comprise at least a part of the first and the second MEA component; and
continuous conveying, with a second vacuum conveyor belt, of the multiple MEA component sections at a second conveying speed; wherein the second conveying speed is higher/greater than the first conveying speed.

### BRIEF DESCRIPTION OF THE DRAWINGS

Further features, properties, advantages and possible modifications will become clear to a person skilled in the art from the following description, in which reference is made to the accompanying drawings. The figures show schematic examples of a membrane-electrode arrangement and a manufacturing device for a membrane-electrode arrangement.

FIG. 1 shows an example of a carrier frame and a membrane electrode assembly, MEA.

FIG. 2 shows an example of a carrier frame with an adhesive applied to it.

FIG. 3 shows an example of the arrangement of a component for a membrane electrode arrangement on a continuous web material.

FIG. 4 shows another example of the arrangement of a component for a membrane electrode arrangement on a continuous web material.

FIG. 5 shows an example of a device for producing a membrane electrode assembly.

FIG. 6 shows a further example of the arrangement of a component for a membrane electrode arrangement on a continuous web material.

FIG. 7 shows another example of a device for producing a membrane electrode assembly.

FIG. 8 shows a further example of the arrangement of a component for a membrane electrode arrangement on a continuous web material and an example of the arrangement of a component for a membrane electrode arrangement on an isolated component section of a web material.

FIG. 9 shows another example of a device for producing a membrane electrode assembly.

FIG. 10 shows another example of a device for producing a membrane electrode assembly.

### DETAILED DESCRIPTION OF THE EMBODIMENTS

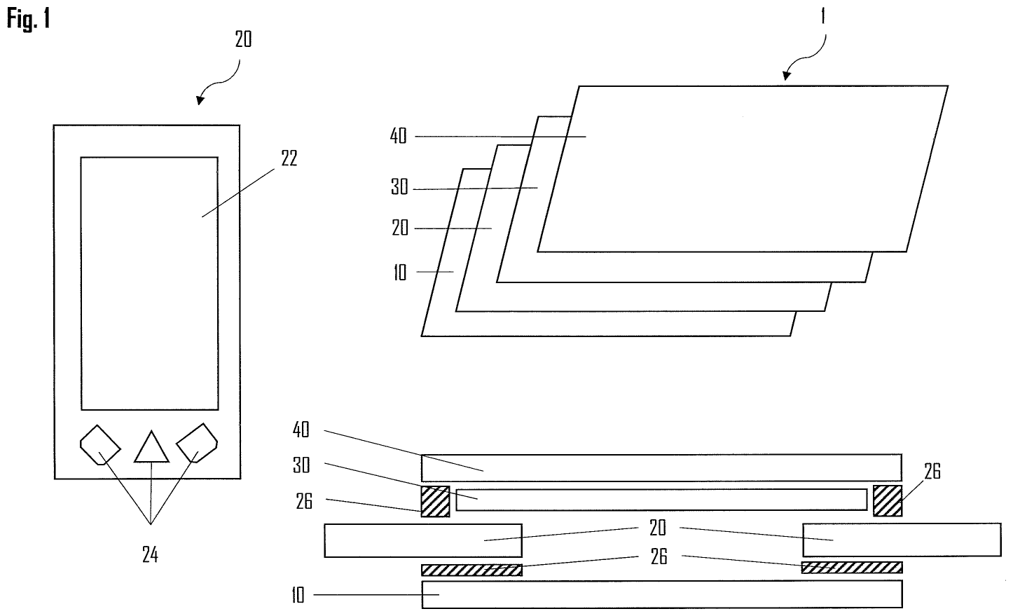

Unless explicitly stated otherwise, identical or functionally comparable components and parts in the schematic FIGS. 1 to 9 are provided with corresponding reference symbols.

FIG. 1 shows a carrier frame 20 for a membrane electrode arrangement 1. The carrier frame 20 has a first recess 22 and several further recesses 24. In the example shown, the carrier frame 20 is already separated from a web material comprising several carrier frames, namely a carrier web. However, this is not absolutely necessary for manufacturing a membrane electrode assembly; MEA. Alternatively, several membrane electrode assemblies can also be manufactured on a continuous carrier web material with several carrier frames and then separated from each other. Sections of a component originally provided as a quasi-infinite web material for a membrane electrode assembly that are separated from each other are component sections.

Furthermore, FIG. 1 schematically shows the structure of a membrane electrode arrangement 1 to be manufactured. The membrane electrode arrangement 1 comprises the carrier frame 20 with the first recess 22. The first recess 22 is formed by an adhesive coating 26, which is applied to the carrier frame 20. A catalyst-coated membrane 30 and a gas diffusion layer, GDL, 40 are arranged on the carrier frame 20 with the adhesive application 26. In the example shown, the gas diffusion layer 40 is a cathode of a membrane electrode arrangement 1. A further adhesive coating 26 and a further GDL 10, in this case an anode, are arranged on the surface of the carrier frame 20 facing away from the cathode 40. In the example shown, the cathode 40 and the anode 10 are each designed as a layer electrode. In other embodiments not shown, the GDL 40 can form an anode and the GDL 10 can form a cathode. In other words, the anode and the cathode of the arrangement shown can be interchanged without further structural modification of the membrane electrode arrangement 1.

In the following, the embodiments shown in the figures are therefore described with an arrangement comprising cathode 40 and anode 10, whereby it is clear that the cathode 40 and the anode 10 are each a GDL and that the anode and cathode can be exchanged with each other as corresponding elements without changing the structure of the devices shown in the figures beyond the exchange of cathode and anode.

As shown in FIG. 1, the catalyst-coated membrane 30 may be disposed on a surface of the cathode 40, wherein both the cathode 40 and the membrane 30 are disposed on the carrier frame 20 with the adhesive coating 26 applied thereto. Optionally, both at least a part of the membrane 30 and a part of the cathode 40 can be arranged directly on the adhesive application 26. The membrane 30 can be at least partially enclosed by the cathode 40 and the carrier frame 20 and/or by the adhesive application 26 due to the arrangement of the cathode 40 on the adhesive application.

In an alternative not shown, the membrane 30 is larger in area than the first recess 22, but smaller in area than the GDL arranged on the membrane. Optionally, the adhesive application 26 applied to the carrier frame 20 can be so large that both the membrane 30 and the GDL arranged on the membrane are fixed/attached to the carrier frame by the adhesive. The adhesive application 26, which can be provided for connecting the membrane 30 and the carrier frame 20, can project beyond the membrane 30 arranged on the carrier frame 20, in particular laterally.

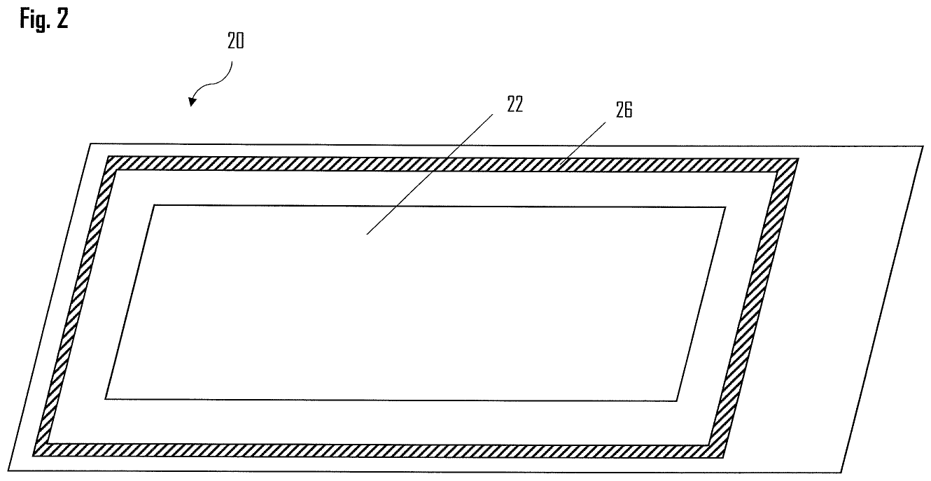

FIG. 2 shows an example of a carrier frame 20 with a first recess 22 and an adhesive application 26 applied to the carrier frame 20, which completely forms the first recess 22, in a schematic perspective view. Optionally, the carrier frame shown can also have further recesses, but these are not shown in FIG. 2 for reasons of clarity. The adhesive application 26 is suitable for fixing a membrane or electrode/GDL to the carrier frame. In the example shown, the adhesive is applied to the carrier frame 20. Alternatively, however, the adhesive can also be applied to an anode/GDL, cathode/GDL or membrane and serve to fix a further component in each case, for example to fix a carrier frame. The first recess 22 of the carrier frame 20 shown can be produced in the same way as any other (not shown) recesses of the carrier frame 20, for example using a punching method or a milling method.

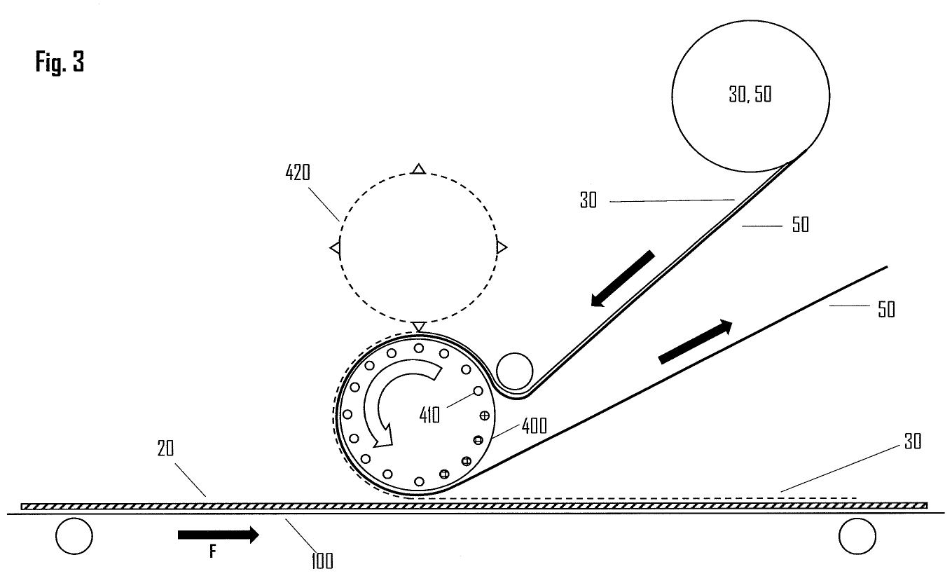

FIG. 3 shows an example of the arrangement of a component for a membrane electrode assembly on a continuous web material. A first MEA component, a membrane 30 in the example shown, is provided by a roll as a quasi-infinite web material. The membrane 30 is arranged on a support web 50 and is provided by the roll together with this support web 50. The membrane 30 and the support web 50 are rolled up together on the schematically shown roll.

FIG. 3 also shows that a carrier web comprising several carrier frames 20, which are not yet separated from one another in the example shown, is conveyed by a vacuum conveyor belt 100 in the conveying direction F. The conveying direction F is the direction in which the vacuum conveyor belt moves the carrier web with the carrier frames 20.

The membrane 30 arranged on the support web 50 is conveyed to the vacuum drum 400, where it is fixed by means of negative pressure and continuously conveyed further by rotating the vacuum drum 400. The support web 50 is made of a material that is more resistant to tension than the membrane 30 and has a greater thickness. The support web 50 at least substantially absorbs the tensile forces generated by the conveying with the vacuum drum and the unrolling from the roller and acting on the web materials, in particular the tensile forces in the conveying direction of the membrane 30 and the support web 50.

In addition, in the example shown, the support web 50 provided as web material is wider than the membrane 30 provided as web material. In other words, the support web 50 projects beyond the membrane 30 on both sides in a direction transverse to the conveying direction of the membrane 30 and the support web 50 shown in FIG. 3. However, this is not necessary in all embodiments.

The vacuum drum 400 has several openings 410. The openings 410 are located in the lateral surface of the vacuum drum 400 and are only shown schematically in the figures for reasons of clarity. The vacuum drum 400 is designed to generate a vacuum and to fix the support web 50 with the membrane 30 arranged thereon to its lateral surface and to convey it without slippage. The generated negative pressure can be selectively activated or deactivated for each of the openings 410. In other words, a negative pressure generated by the vacuum drum 400 can be applied for each individual opening 410 and then neutralized or cancelled again, whereby the application and cancellation of the negative pressure for each of the openings 410 can occur independently of the respective other openings. Optionally, the openings 410 can be selectively closed or opened for this purpose, but this is not necessary in all embodiments.

The supporting web 50 is permeable to air, so that the membrane 30 arranged on the supporting web 50 is also sucked in or fixed by the vacuum generated by the vacuum drum 400. Thus, both the membrane 30 and the supporting web 50 arranged between the sucked-in membrane 30 and the circumferential surface of the vacuum drum are fixed by the vacuum drum 400 and continuously conveyed without slippage.

By rotating about an axis of rotation, the vacuum drum 400 conveys the membrane 30 arranged on the support web 50 to a cutting cylinder 420, which is configured to cut the membrane 30 into several individual component sections, in the example shown into several membrane sections, without cutting the support web 50 in the process. However, this is not necessary in all embodiments; the membrane 30 can alternatively be conveyed further without being cut. In the example shown, the cut membrane 30, or in other words the membrane sections produced in this way, is continuously conveyed further by the vacuum drum 400 without the cutting with the cutting cylinder changing the positioning of the membrane or membrane sections on the support web. The membrane sections can thus be produced at high speed and with high accuracy, with the support web 50 here protecting the surface of the vacuum drum 400 from direct contact with the blades or cutting tools of the cutting cylinder 420.

Furthermore, in the example shown in FIG. 3, the vacuum drum 400 is configured to convey the cut membrane 30 or the membrane sections to a transfer position and to arrange the membrane sections on the carrier frame 20 at this transfer position. In the example shown, one membrane section is arranged on each of the carrier frames 20, which are not yet separated from one another. In other embodiments, however, several MEA component sections can also be arranged on one carrier frame each.

In the example shown, the vacuum drum 400 is configured to arrange one of the membrane sections on each of the carrier frames 20 in such a way that a first recess 22 of the respective carrier frame 20 of the carrier web is covered/covered in each case. For this purpose, the membrane sections are each larger in area than the respective first recess 22 in the carrier frame 22.

In the example shown, the vacuum drum 400 is arranged and designed to press the cut membrane 30 or the membrane sections against the carrier frame 20 and at the same time to neutralize the negative pressure with which the membrane sections are fixed to the lateral surface of the vacuum drum 400. By neutralizing the negative pressure for the membrane sections positioned at the transfer position, these are released and remain on the carrier frame 20. In an alternative not shown, a negative pressure exerted on the membrane 30 or the membrane sections by the vacuum conveyor belt 100 can also be greater than the negative pressure exerted on the membrane 30 or the membrane sections by the vacuum drum 400, so that the membrane 30 or the membrane sections remain on the carrier frame 20, which in particular have recesses.

The membrane sections are then removed or transported onwards together with the carrier frames 20 in the conveying direction F by the vacuum conveyor belt 100. Optionally, an adhesive (not shown) may have been previously applied to the respective carrier frame 20, which causes or at least improves adhesion of the membrane sections to the carrier frame 20. In particular, the adhesive can be an adhesive that hardens under UV light and surrounds or forms a frame around one or more recesses in the carrier frame.

In the example shown in FIG. 3, the openings 410 in the lateral surface of the vacuum drum 400 are closed when the vacuum is released or neutralized. For a renewed fixing of the continuously supplied support web 50 and the membrane 30, the respective openings 410 can be reopened and/or activated after a rotation of the vacuum drum 400 by a certain angle. However, both are expressly not necessary in all embodiments. Further, the vacuum drum shown in FIG. 3 may have an adhesion-reducing coating on its peripheral surface/surface, for example a Teflon coating. In other embodiments, the vacuum drum may also have a rubber or plastic coating on its circumferential surface/surface and/or be at least partially made of a rubber or plastic material.

After the cut membrane 30 or the membrane sections have been arranged on the carrier frame 20 and the negative pressure with which the support web 50 and the membrane sections were fixed on the lateral surface of the vacuum drum has been released, the support web, as shown in FIG. 3, is transported away or onward separately from the membrane sections. In other words, after the membrane sections have been placed on the support frame 20, the support web 50 is conveyed further without the membrane sections.

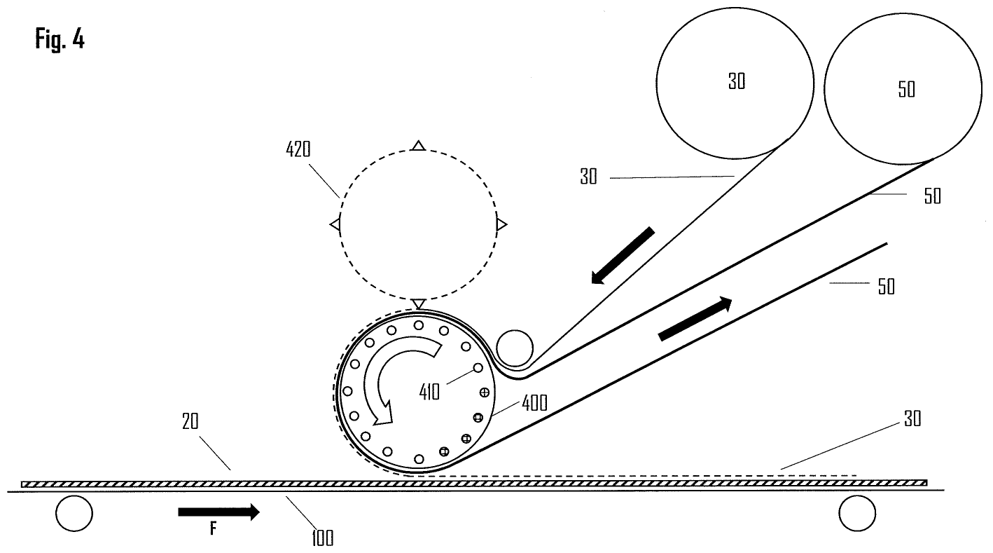

FIG. 4 shows an alternative implementation example with a membrane supply roll and a separate support web supply roll. In the example shown in FIG. 4, the membrane 30 is provided by a separate membrane providing roller and the support web 50 is provided by a separate support web providing roller. The membrane 30 and the support web 50 are each conveyed to the vacuum drum 400, wherein the membrane 30 is previously arranged on the support web 50. More precisely, the membrane 30 is arranged on the air-permeable support web 50 in such a way that the support web 50 is arranged between the lateral surface of the vacuum drum 400 with the openings 410 and the membrane 30. The membrane 30 is thus arranged on a surface of the supporting web 50 facing away from the circumferential surface of the vacuum drum 400.

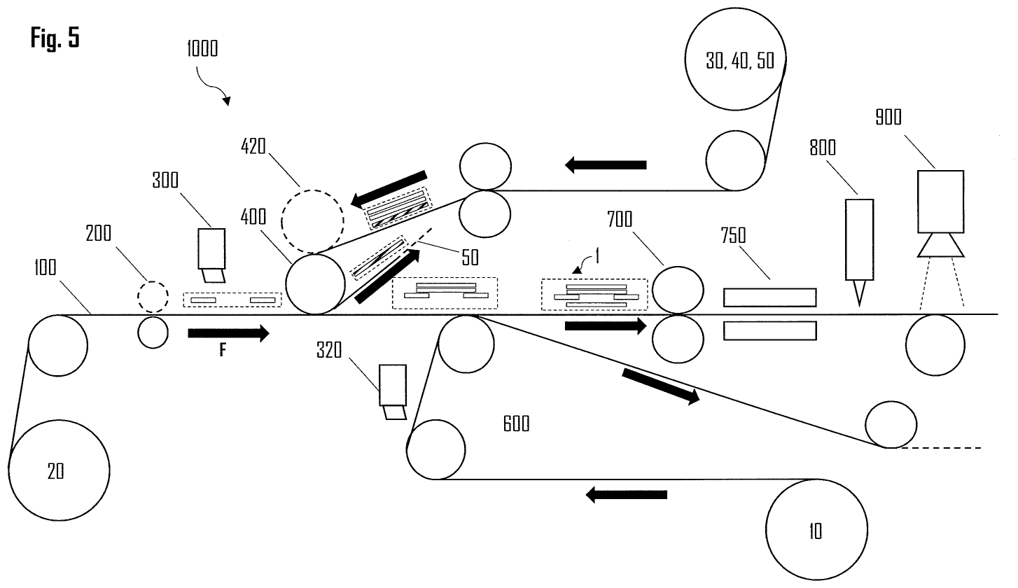

FIG. 5 shows an example of a device 1000 for manufacturing membrane electrode assemblies 1.

In the example shown, several carrier frames 20 are provided as a continuous quasi-infinite roll material and are continuously conveyed past various production stations in the conveying direction F by a conveyor device 100. The production stations each carry out processing steps to produce a membrane electrode arrangement and/or provide production components for this.

In a first exemplary processing step, a milling or punching device 200 introduces the first recess 22 and the further recesses 24 into the respective carrier frame 20 of the carrier web. During the insertion of the first recess 22 and/or the further recesses 24, the carrier frame 20 can continue to be conveyed continuously in the conveying direction F. Depending on the embodiment, the first recesses 22 and the further recesses 24 can be introduced into the carrier frame by the same or by different devices. In alternative embodiments of the manufacturing device 1000, the carrier frames 20 can also be provided with recesses 22, 24 already introduced, so that the milling or punching device 200 for manufacturing membrane electrode arrangements can also be dispensed with.

Subsequently, in the example shown, an adhesive application 26 is applied to the carrier frame 20, which reshapes the first recess 22 of the carrier frame 20. For this purpose, the device 1000 comprises the application device 300. The continuous conveying of the carrier frame 20 by the conveying device 100 is not interrupted during the application of the adhesive 26. The adhesive application 26 can in particular be an adhesive that hardens under UV light. In an alternative of the device for manufacturing membrane electrode arrangements, which is not shown, the device may further comprise a UV curing station which is configured to at least partially cure the adhesive application by means of UV light.

Furthermore, the device 1000 shown has a first vacuum drum 400, which arranges a catalyst-coated membrane 30 and a cathode 40 in the form of a GDL on the carrier frame 20 with the adhesive application 26. The vacuum drum 400 enables the slip-free continuous conveying of the MEA components 30, 40 and arranges both the membrane 30 and the cathode/GDL 40 on the continuously conveyed carrier frame 20. This is made possible by the fact that the membrane 30 and the cathode 40 are provided together with a support web 50 and then cut into several MEA component sections by the cutting cylinder 420, while they are fixed by the vacuum drum 400. After the MEA component sections have been arranged on the carrier frame 20, the support web 50 is conveyed separately from them.

In other words, the first vacuum drum 400 can be configured to arrange a first electrode or a first GDL on the carrier frame 20 with the adhesive application 26, wherein a catalyst-coated membrane 30 is arranged on a surface of the electrodes or GDL facing the carrier frame 20 during the arrangement, so that the membrane sections are arranged between the carrier frame 20 and the electrodes or GDL after the arrangement and/or are arranged in the first recess 22 of the carrier frame 20.

Furthermore, the device shown has a further arranging device 600, which also comprises a vacuum drum and is configured to arrange an anode 10 or second GDL on a side of the carrier frame 20 facing away from the cathode 40 or first GDL. For this purpose, a further application of adhesive can be applied beforehand either to the anode/GDL 10 or to the side of the carrier frame 20 facing away from the cathode/GDL 40. In the example shown, the anodes/GDL 10 are provided as already separated MEA components on a support web and provided with an adhesive application by the application device 320. In another embodiment, not shown, the second GDL can be provided as an endless web and separated into several MEA component sections by cross-cutting before being transferred to/on the vacuum drum.

Furthermore, the manufacturing device 1000 shown has a pressing device 700 with two unheated pressing rollers and an adhesive curing device 750. In other embodiments not shown, the adhesive curing device 750 can also be omitted. The pressing device 700 is arranged and designed to press the electrodes or GDL 10, 40 against the membrane 30 and/or the carrier frame 20. The adhesive curing device 750 is arranged and designed to heat the membrane-electrode arrangement 1 and/or to irradiate it with UV light and thereby cure it.

After the adhesive application has cured, the individual carrier frames 20 or manufactured membrane electrode assemblies 1 can be separated from each other using a separating device 800. However, the separation of the carrier frames 20 from each other does not have to take place at this point. Alternatively, the membrane-electrode assemblies can also be manufactured with individual carrier frames which have already been separated from each other before or during the arrangement of the membrane 30 and/or the electrodes/GDL 10, 40. In one embodiment, the separation of the individual carrier frames 20 or the manufactured membrane-electrode arrangements 1 can be carried out using a rotary punch. The membrane electrode assemblies 1 are punched out of the carrier web by means of a cross-section and a longitudinal cut at the edge. A remaining punching grid/reject grid can then be removed or conveyed away from the separated/separated membrane electrode assemblies 1.

FIG. 5 also shows the inspection device 900, which comprises at least one camera sensor and is configured to determine position and/or property errors of the manufactured membrane electrode arrangements 1 on the transport device 100. Depending on this determination, the membrane electrode arrangements 1 can be conveyed by the transport device 100 either into a reject receptacle or into a depositing device.

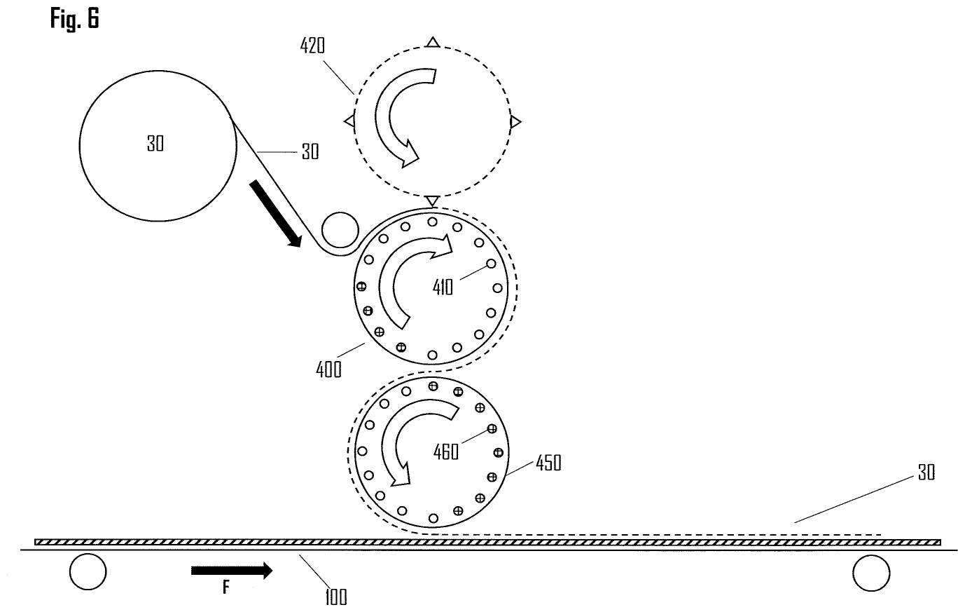

FIG. 6 shows a further example of the arrangement of a component for a membrane electrode assembly on a continuous web material. A first MEA component, in this case a carrier web comprising several carrier frames 20, which are not yet separated from one another in the example shown, is conveyed by a vacuum conveyor belt 100 in the conveying direction F. The conveying direction F is the direction in which the vacuum conveyor belt moves the carrier web with the carrier frames 20. In other embodiments not shown, the continuous web material can also be a GDL and/or a membrane on which further MEA components are arranged in each case.

A second MEA component, in the example shown a membrane 30, is provided by a roll as a quasi-infinite web material. The membrane 30 is conveyed, in the example shown at least essentially free of tension, to the first vacuum drum 400 and fixed by the latter by means of negative pressure and continuously conveyed further by rotation of the vacuum drum 400. The first vacuum drum 400 has several openings 410 for this purpose. The openings 410 are located in the lateral surface of the vacuum drum 400 and are only shown schematically in the figures for reasons of clarity. The first vacuum drum 400 is designed to generate a vacuum in order to fix the membrane 30 to its lateral surface and to convey it without slippage. The generated vacuum can be selectively activated or deactivated for each of the openings 410. In other words, a negative pressure generated by the first vacuum drum 400 can be applied for each individual opening 410 and then neutralized or cancelled again, whereby the application and cancellation of the negative pressure for each of the openings 410 can occur independently of the respective other openings. Optionally, the openings 410 can be selectively closed or opened for this purpose, but this is not necessary in all embodiments. In a further embodiment, not shown, the vacuum drum 400 can exert a tensile force on the membrane 30 to be supplied in order to unwind it from the supply roll. In particular, the membrane can be fed in a clamping manner between the guide roller shown in FIG. 6 and the vacuum drum 400.

By rotating about an axis of rotation, the first vacuum drum 400 conveys the membrane 30 to a cutting cylinder 420, which is arranged to cut the membrane 30 into a plurality of individual component sections, in the example shown into a plurality of membrane sections. However, this is not necessary in all embodiments; the membrane 30 can alternatively be conveyed further without being cut. In the example shown, the cut membrane 30, or in other words the membrane sections produced in this way, is continuously conveyed further by the first vacuum drum without the cutting with the cutting cylinder changing the positioning of the membrane or membrane sections. The membrane sections can thus be produced with high speed and accuracy. The first vacuum drum 400 shown in FIG. 6 has a rubber coating on its shell surface or jacket surface, which on the one hand protects the blades of the cutting cylinder 420 from damage due to direct contact with the shell surface or jacket surface of the first vacuum drum 400 and on the other hand is also not damaged by direct contact with the blades of the cutting cylinder 420. Alternatively, the first vacuum drum can also have a plastic coating and/or a coating made of another suitable material.

Furthermore, in the example shown in FIG. 6, the first vacuum drum 400 is configured to convey the cut membrane 30 or the membrane sections to a transfer position and to arrange the membrane sections at this transfer position on the lateral surface/surface of a further or second vacuum drum 450. The further or second vacuum drum 450 is at least substantially functionally identical to the first vacuum drum 400, but rotates in a direction opposite to the direction of rotation of the first vacuum drum 400 and has an adhesion-reducing surface coating, for example a Teflon coating.

In the example shown, the first vacuum drum 400 is arranged and designed to press the cut membrane 30 or the membrane sections against the second vacuum drum 450 and, at the same time, to neutralize the negative pressure with which the membrane sections are fixed to the lateral surface of the first vacuum drum 400. By neutralizing the negative pressure for the membrane sections positioned at the transfer position, these are released. At the same time, the second vacuum drum 450 sucks in the membrane sections by means of a vacuum through the openings 460 in its jacket surface and thus fixes them to its jacket surface or surface.

By means of a rotation of the second vacuum drum 450, the cut membrane 30 or the membrane sections is/are conveyed to a further transfer position and arranged there on the carrier frame 20. In the example shown, the second vacuum drum 450 is arranged and designed to press the cut membrane 30 or the membrane sections onto the carrier frame 20 and, at the same time, to neutralize the negative pressure with which the membrane sections are fixed to the lateral surface of the second vacuum drum 450. By neutralizing the negative pressure for the membrane sections positioned at the transfer position, these are released and remain on the carrier frames 20. The membrane sections are then transported away or onwards together with the carrier frames 20 in the conveying direction F by the vacuum conveyor belt 100. Optionally, an adhesive may have been previously applied to the respective carrier frame 20, which causes or at least improves adhesion of the membrane sections to the carrier frame 20.

In the example shown in FIG. 6, the openings 460 in the lateral surface of the second vacuum drum 450 are closed when the vacuum is released or neutralized. For fixing further membrane sections in each case, the respective openings 460 can be reopened and/or activated after a rotation of the second vacuum drum 460 by a certain angle. However, both are expressly not necessary in all embodiments.

Furthermore, the second vacuum drum 450 shown in FIG. 6 can have an adhesion-reducing coating on its outer surface, for example a Teflon coating. This facilitates and improves the arrangement of the membrane sections on the carrier frame 20. In addition, possible contamination of the second vacuum drum 450 by an adhesive that gets onto the second vacuum drum 450 during the arrangement of the membrane sections on the carrier frame 20 can be removed particularly well by an adhesion-reducing coating.

In the example shown, one membrane section is arranged on each of the carrier frames 20, which are not yet separated from one another. In particular, a respective first recess 22 of a respective carrier frame 20 of the carrier web can be covered/covered by the respective membrane sections. For this purpose, the membrane sections can be larger than the respective first recesses 22. An adhesive may have been arranged on the respective carrier frames 20 such that it surrounds/forms the first recesses 22 in a frame-like manner and/or projects laterally or transversely to the conveying direction of the carrier frames 20 over the respective membrane sections arranged on the carrier frames. In other embodiments, several MEA component sections can also be arranged on a respective carrier frame.

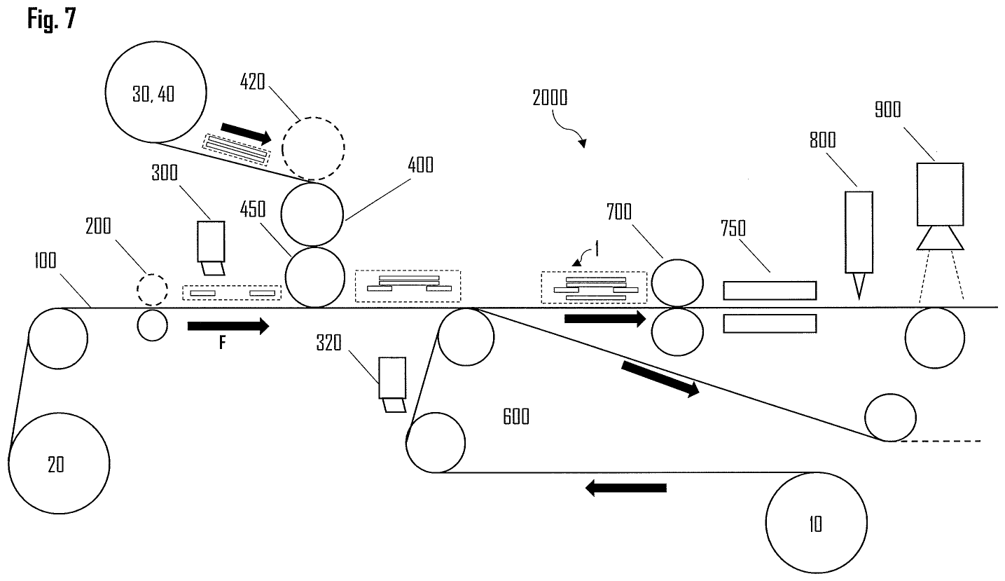

FIG. 7 shows a further example of a device 2000 for manufacturing membrane electrode assemblies 1.

In the example shown, several carrier frames 20 are provided as a continuous quasi-infinite roll material and are continuously conveyed past various production stations in the conveying direction F by a conveyor device 100. The production stations each carry out processing steps to produce a membrane electrode arrangement and/or provide production components for this.

In a first exemplary processing step, a milling or punching device 200 introduces the first recess 22 and the further recesses 24 into the carrier frame 20. During the insertion of the first recess 22 and/or the further recesses 24, the carrier frame 20 can continue to be conveyed continuously in the conveying direction F. Depending on the embodiment, the first recesses 22 and the further recesses 24 can be introduced into the carrier frame by the same or by different devices. In alternative embodiments of the manufacturing device 2000, the carrier frames 20 can also be provided with recesses 22, 24 already introduced, so that the milling or punching device 200 for manufacturing membrane electrode arrangements can also be dispensed with.

Subsequently, in the example shown, an adhesive application 26 is applied to the carrier frame 20, which forms the first recess 22 of the carrier frame 20. For this purpose, the device 2000 comprises the application device 300. The continuous conveying of the carrier frame 20 by the conveying device 100 is not interrupted during the application of the adhesive 26.

Furthermore, the device 2000 shown has a first vacuum drum 400 and a second vacuum drum 450, which arrange a catalyst-coated membrane 30 and a cathode or first GDL 40 on the carrier frame 20 with the adhesive application 26. The vacuum drums 400, 450 each enable the slip-free continuous conveying of the MEA components 30, 40 and arrange both the membrane 30 and the cathode/GDL 40 on the continuously conveyed carrier frame 20. This is made possible by the fact that the membrane 30 and the cathode/GDL 40 are provided together and then cut into several MEA component sections by the cutting cylinder 420, while they are fixed by the first vacuum drum 400. The MEA component sections are then fixed by the second vacuum drum 450 and arranged on the carrier frame 20 by the latter.

In other words, it can be described that the vacuum drums 400, 450 are configured to arrange a first electrode on each of the carrier frames 20 with the adhesive application 26, wherein a catalyst-coated membrane 30 is arranged on a surface of the electrodes facing the carrier frames 20 during the arrangement, so that the membrane sections are arranged between the carrier frames 20 and the electrodes after the arrangement and/or are arranged in the first recess of the carrier frames 20.

Furthermore, the device shown has a further arranging device 600, which also comprises a vacuum drum and is configured to arrange an anode/GDL 10 on a side of the carrier frame 20 facing away from the cathode/GDL 40. For this purpose, a further application of adhesive can be applied beforehand either to the anode/GDL 10 or to the side of the carrier frame 20 facing away from the cathode/GDL 40. In the example shown, the anodes 10 are provided as already separated MEA components on a support web and provided with an adhesive application by the application device 320. In another embodiment, not shown, the second GDL or anode 10 can be provided as an endless web and separated into several MEA component sections by cross-cutting before being transferred to/on the vacuum drum.

Furthermore, the manufacturing device 2000 shown has a pressing device 700 and an adhesive curing device 750. In other embodiments not shown, the adhesive curing device 750 can also be omitted. The pressing device 700 is arranged and designed to press the electrodes 10, 40 against the membrane 30 and/or against the carrier frame 20. The adhesive curing device 750 is arranged and designed to heat the membrane-electrode arrangement 1 and/or to irradiate it with UV light, thereby curing it.

After the adhesive application has hardened, the individual carrier frames 20 or manufactured membrane electrode assemblies 1 can be separated from each other using a separating device 800. However, the separation of the carrier frames 20 from each other does not have to take place at this point. Alternatively, the membrane-electrode assemblies can also be manufactured with individual carrier frames which have already been separated from each other before or during the arrangement of the membrane 30 and/or the electrodes/GDL 10, 40. In one embodiment, the separation of the individual carrier frames 20 or the manufactured membrane-electrode arrangements 1 can be carried out using a rotary punch. The membrane-electrode assemblies 1 are punched out of the carrier web by means of a cross-section and a longitudinal cut at the edge. A remaining punching grid/reject grid can then be removed or conveyed away from the separated/separated membrane electrode assemblies 1.

FIG. 7 also shows the inspection device 900, which comprises at least one camera sensor and is configured to determine position and/or property errors of the manufactured membrane electrode arrangements 1 on the transport device 100. Depending on this determination, the membrane electrode arrangements 1 can be conveyed by the transport device 100 either into a reject receptacle or into a depositing device.

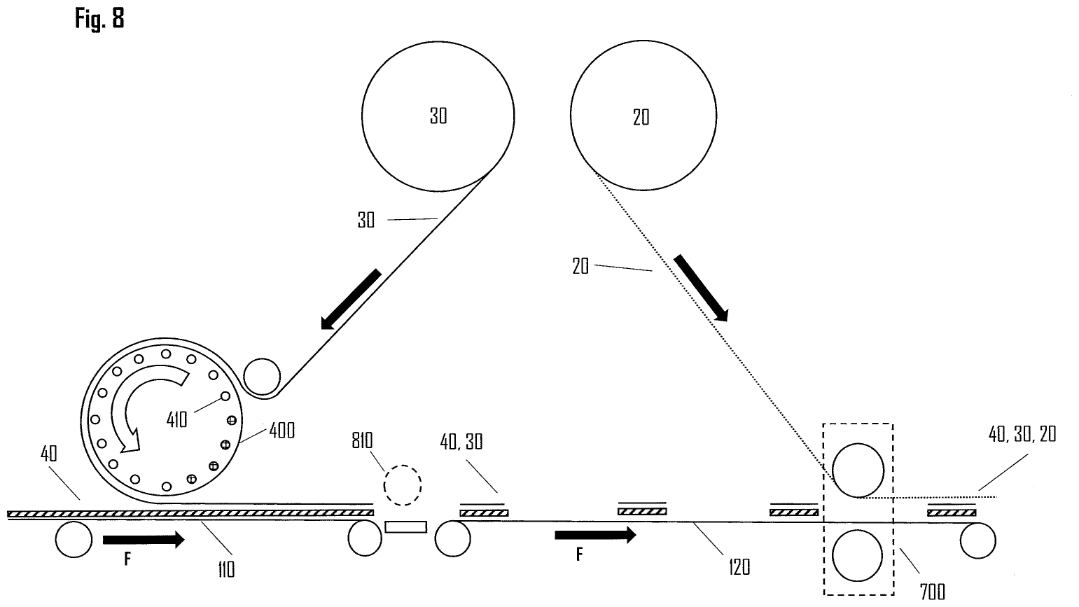

FIG. 8 shows a further example of the arrangement of a component for a membrane electrode arrangement on a continuous web material and an example of the arrangement of a component for a membrane electrode arrangement on an isolated component section of a web material.

A first MEA component, in the example shown a membrane 30, is provided by a roll as a quasi-infinite web material. FIG. 8 further shows that an electrode 40 in the form of a gas diffusion layer, GDL, is conveyed by a first vacuum conveyor belt 110 in the conveying direction F. The conveying direction F is the direction in which the vacuum conveyor belt moves the GDL or electrode 40. In the example shown, the electrode 40 is a cathode that is provided as a continuous web material and is conveyed without slippage in the conveying direction F by the first vacuum conveyor belt 110.

In the example shown, the membrane 30 is conveyed, at least essentially free of tension, to the first vacuum drum 400 and fixed by the latter by means of negative pressure and, by rotation of the first vacuum drum 400, continuously conveyed further.

The first vacuum drum 400 has several openings 410. The openings 410 are located in the lateral surface of the vacuum drum 400 and are only shown schematically in the figures for reasons of clarity. The first vacuum drum 400 is designed to generate a vacuum and to fix the membrane 30 on its lateral surface and to convey it without slippage. The generated negative pressure can be selectively activated or deactivated for each of the openings 410. In other words, a negative pressure generated by the first vacuum drum 400 can be applied for each individual opening 410 and then neutralized or cancelled again, whereby the application and cancellation of the negative pressure for each of the openings 410 can occur independently of the respective other openings. Optionally, the openings 410 can be selectively closed or opened for this purpose, but this is not necessary in all embodiments.

Furthermore, in the example shown in FIG. 8, the first vacuum drum 400 is arranged to convey the membrane 30 to a transfer position and to arrange it on the GDL at this transfer position. In the example shown, the first vacuum drum 400 is further arranged and designed to press the membrane 30 against the GDL or cathode 40 and, at the same time, to neutralize the negative pressure with which the membrane sections are fixed to the circumferential surface of the vacuum drum 400. By neutralizing the negative pressure for the membrane positioned at the transfer position, it is released and remains on the GDL or cathode 40. The membrane is then transported further together with the GDL or cathode 40 in the conveying direction F by the first vacuum conveyor belt 110. Optionally, an adhesive may have been previously applied to the GDL or cathode 40 and/or to the membrane, which causes or at least improves adhesion of the membrane to the GDL or cathode 40. For example, the adhesive may be applied to the GDL as an adhesive frame that encloses/encloses or reshapes an adhesive-free area. The adhesive frame can be used to bond the membrane (sections) in the edge area to the GDL.

In the example shown in FIG. 8, the openings 410 in the lateral surface of the first vacuum drum 400 are closed when the vacuum is released or neutralized. For a renewed fixing of the continuously supplied membrane 30, the respective openings 410 can be reopened and/or activated after a rotation of the first vacuum drum 400 by a certain angle. However, both are expressly not necessary in all embodiments. In other embodiments not shown, for example, a negative pressure exerted by the first vacuum conveyor belt on the membrane and/or on a part of the membrane may also be greater than a negative pressure exerted by the vacuum drum on the membrane, so that the vacuum conveyor belt can detach the membrane from the vacuum drum and/or can at least support a detachment of the membrane from the vacuum drum. Further, the first vacuum drum 400 shown in FIG. 8 may have an adhesion-reducing coating on its peripheral surface/surface, for example a Teflon coating. In other embodiments, the first vacuum drum 400 may also have a rubber or plastic coating on its peripheral surface/surface and/or be at least partially made of a rubber or plastic material.

After arranging the cut membrane 30 on the GDL or cathode 40, these are conveyed onwards together by the first vacuum conveyor belt. In the example shown, the membrane 30 with the GDL or cathode 40 are conveyed to a first cutting device 810, which is arranged to cut the first MEA component provided as web material, here the cathode 40 in the form of a GDL, with the second MEA component arranged at least partially thereon, here with the membrane 30, into a plurality of MEA component sections, each comprising at least a part of the first and the second MEA component. In other embodiments, the second MEA component, for example a membrane and/or a GDL, may also be arranged on the first MEA component already cut up. In this case, the first cutting device 810 may be arranged to cut the first MEA component with the second MEA component arranged thereon, in this case already cut into a plurality of sections, into a plurality of MEA component sections, each comprising at least a part of the first and second MEA components.

In the example shown, the first cutting device is a cutting cylinder 810, which interacts with a cutting support, in this case a cutting table/cutting anvil, over which the MEA components are guided for cutting. In the example shown, the MEA components are conveyed onto and over the cutting support by the first vacuum conveyor belt 110.

Subsequently, the MEA component sections, each comprising at least a portion of the first and second MEA components, are arranged or transported from the first vacuum conveyor belt 110 and/or the cutting support onto a second vacuum conveyor belt 120. The second vacuum conveyor belt 120 has a distance of about 1 cm from the first vacuum conveyor belt, so that the MEA component sections can be fed from the first vacuum conveyor belt 110 directly onto the second vacuum conveyor belt via the cutting support. However, in other embodiments not shown, any other spacing between the first and second vacuum conveyor belts can be realized, with these embodiments not shown having all other features of the embodiment shown here. In further embodiments not shown, the device can also have, for example, a vacuum gripper which removes the MEA component sections from the first vacuum conveyor belt 110 and arranges them on the second vacuum conveyor belt 120. However, this is expressly not necessary in all embodiments. Furthermore, the first vacuum conveyor belt can optionally also cancel or neutralize a negative pressure with which the MEA component sections are fixed on the first vacuum conveyor belt in order to enable or facilitate the arrangement or transport of the MEA component sections from the first vacuum conveyor belt 110 to/on the second vacuum conveyor belt.

The second vacuum conveyor belt 120 conveys the MEA component sections at a higher speed than the first vacuum conveyor belt 110. This increases a distance between the MEA component sections conveyed in each case, so that further component or component sections can now also be arranged on these, which project beyond the previously produced MEA component sections in the conveying direction F or which are larger than the previously produced MEA component sections. In the example shown in FIG. 8, a carrier frame 20 is arranged in each case on the MEA component sections conveyed by the second vacuum conveyor belt 120, the carrier frame 20 projecting beyond the MEA component sections in the conveying direction in each case.

The carrier frames 20 are provided as a continuous, quasi-infinite carrier web from a carrier web roller. The continuous carrier web, which comprises a plurality of carrier frames 20, is guided, in the example shown at least substantially tension-free, to a lamination device 700, which connects the carrier web to the carrier frames with the manufactured MEA component sections. The lamination device 700 is a roller lamination device.

In the example shown in FIG. 8, the lamination device 700 is arranged to convey the carrier web with the carrier frames 20 to a transfer position and to arrange the carrier web with the carrier frames 20 at this transfer position on the MEA component sections conveyed by the second vacuum conveyor belt 120. In the example shown, the lamination device 700 is further arranged and designed to press the carrier frames 20 onto the MEA component sections conveyed by the second vacuum conveyor belt.

In the example shown, the carrier frames 20 are arranged on the MEA component sections conveyed by the second vacuum conveyor belt 120 in such a way that the MEA component sections completely cover a first recess in the respective carrier frame 20 and leave a second recess in the respective carrier frame 20 at least partially uncovered/open. Subsequently, the MEA component sections with the carrier frames 20 arranged thereon are transported away or further in the conveying direction F by the second vacuum conveyor belt 120.

Optionally, an adhesive application may have been previously arranged on the respective carrier frames 20 and/or on the MEA component sections conveyed by the second vacuum conveyor belt 120. The adhesive application may, for example, have one or more frame-shaped sections. These frame-shaped sections may, for example, surround and/or reshape a first recess in the carrier frames.

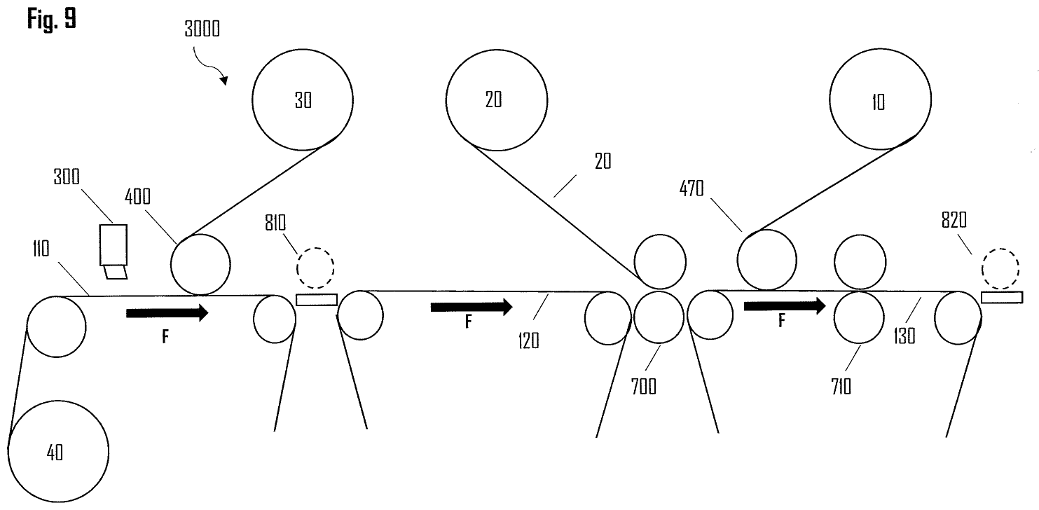

FIG. 9 shows a further example of a device 3000 for producing a membrane electrode arrangement.

In the example shown, a cathode 40 in the form of a GDL is provided as a continuous quasi-infinite web material and is continuously conveyed past various production stations in the conveying direction F by the first vacuum conveyor belt 110. The manufacturing stations each perform processing steps for manufacturing a membrane electrode arrangement and/or provide manufacturing components for this. Other embodiments, not shown, can also have only a single manufacturing station.

In the example shown, an adhesive is applied to the GDL or cathode 40, for which purpose the device 3000 comprises the application device 300. The continuous conveying of the GDL or cathode 40 by the first vacuum conveyor belt 110 is not interrupted during the application of the adhesive 26.

Further, the shown device 3000 has at least a first vacuum drum 400 which, as described with respect to FIG. 8, arranges a membrane 30 on the GDL or cathode 40. In order to increase a distance between MEA component sections produced with a first cutting device 810, the MEA component sections are conveyed or transferred from the first vacuum conveyor belt 110 to the second vacuum conveyor belt 120, wherein the second vacuum conveyor belt 120 has a higher conveying speed than the first vacuum conveyor belt 110. This makes it possible for a lamination device 700 to also arrange such components or component sections, in this case the carrier web with the carrier frames 20, on the MEA component sections which protrude over them in the conveying direction F of the second vacuum conveyor belt 120. The conveying direction F of the second vacuum conveyor belt can in particular be the same direction in which the first vacuum conveyor belt 110 conveys the MEA components or MEA component sections.

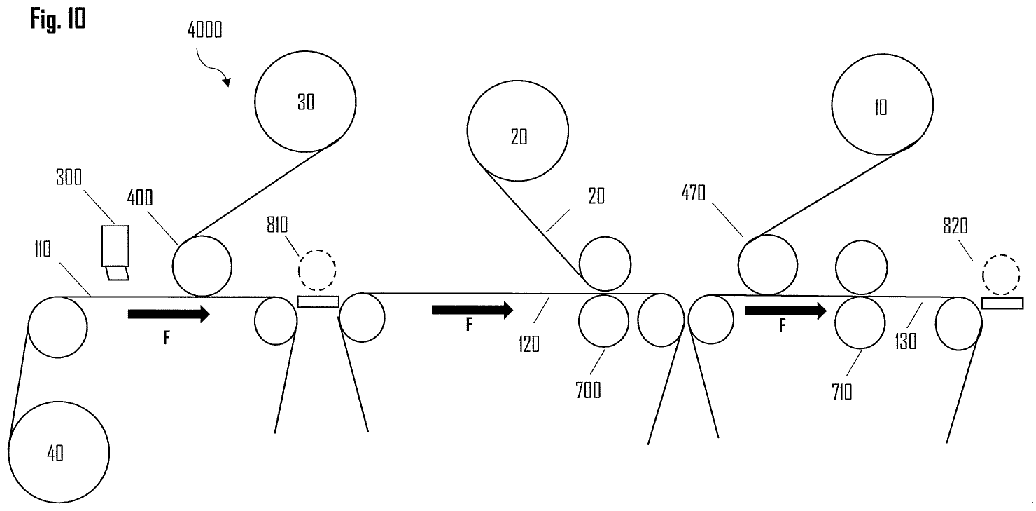

The lamination device 700 can either be arranged between the second vacuum conveyor belt 120 and an additional vacuum conveyor belt 130, as shown in FIG. 9, or, as shown in FIG. 10 as an alternative device 4000, be arranged and designed to arrange the carrier web with the carrier frames 20 on the MEA component sections conveyed by the second vacuum conveyor belt 120. In both examples shown in FIGS. 9 and 10, the lamination device 700 is a roller lamination device arranged and configured to press the MEA component sections onto the carrier frames 20 and to bond the MEA component sections to the carrier frames.

Furthermore, the device 3000 shown has the additional vacuum conveyor belt 130, which receives the carrier web with the MEA component sections or takes them over from the lamination device and/or the second vacuum conveyor belt. An additional vacuum drum 470 is arranged and designed to arrange an anode or GDL 10 on the surface of the respective carrier frame 20 facing away from the cathode 40. The GDL or anode 10 is provided as a continuous quasi-infinite web material from a roll, guided to the additional vacuum drum 470 and fixed to a lateral surface of the vacuum drum 470. An additional cutting cylinder 440 cuts the GDL or anode 10 provided as continuous web material into several MEA component sections, in this case anode sections. The additional vacuum drum 470 then arranges one MEA component section or anode section on each of the carrier frames or MEA component sections conveyed by the additional vacuum conveyor belt 130. The mode of operation of the third vacuum drum 470 corresponds at least essentially to the mode of operation of the first vacuum drum.

FIGS. 9 and 10 also show the rotary die cutter 810. The rotary die cutter 810 is designed to produce or punch out membrane electrode assemblies 1 from the carrier web with the MEA component sections and GDL arranged thereon. The membrane electrode assemblies 1 are punched out of the carrier web by means of a cross-section and a transverse longitudinal cut. A remaining punched grid/spacer grid can then be removed or conveyed away from the separated/separated membrane electrode assemblies 1.

The variants described above merely serve to provide a better understanding of the structure, mode of operation and properties of the objects disclosed herein; they do not limit the disclosure to the embodiments. The figures are schematic, whereby essential properties and effects are shown, in some cases clearly enlarged, in order to clarify the functions, operating principles, technical embodiments and features. In this context, each mode of operation, each principle, each technical configuration and each feature disclosed in the figures or in the text can be freely and arbitrarily combined with all claims, each feature in the text and in the other figures, other modes of operation, principles, technical configurations and features contained in this disclosure or resulting therefrom, so that all conceivable combinations can be assigned to the described procedure. This also includes combinations between all individual embodiments in the text, i.e. in each section of the description, in the claims and also combinations between different variants in the text, in the claims and in the figures. Nor do the claims limit the disclosure and thus the possible combinations of all the features disclosed. All disclosed features are also explicitly disclosed individually and in combination with all other features herein.

1. An apparatus for manufacturing a membrane electrode assembly, MEA, comprising:
a first vacuum conveyor belt adapted to continuously convey a first MEA component in the form of a web material at a first conveying speed;
a first arranging device adapted to arrange a second MEA component at least partially on the first MEA component while the first MEA component is continuously conveyed by the first vacuum conveyor belt;
a first cutting device configured to cut the first MEA component with the second MEA component arranged at least partially thereon into a plurality of MEA component sections, wherein each component section includes at least a part of the first and second MEA components; and
a second vacuum conveyor belt adapted to continuously convey the plurality of MEA component sections at a second conveying speed, wherein the second conveying speed is higher than the first conveying speed.

2. The apparatus according to claim 1, wherein
the first MEA component includes a gas diffusion layer, GDL, having an anode or a cathode and/or
the second MEA component includes a membrane.

3. The apparatus according to claim 1, wherein the first arranging device is configured to provide the second MEA component as a continuous web material or as individual web material sections.

4. The apparatus according to claim 1, further comprising a transfer device adapted to move the MEA component sections from the first vacuum conveyor belt to the second vacuum conveyor belt.

5. The apparatus according to claim 1, further comprising a second arranging device associated with the second vacuum conveyor belt, said second arranging device being configured to arrange a third MEA component including a carrier frame on one of the plurality of MEA component sections while the component sections are being continuously conveyed by the second vacuum conveyor belt.

6. The apparatus according to claim 5, wherein
the carrier frame has at least two recesses, and
the second arranging device is configured to arrange the carrier frame on one of the plurality of MEA component sections so that the MEA component sections completely cover one of the recesses and leave another of the recesses at least partially uncovered.

7. The apparatus according to claim 5, wherein the second arranging device is adapted to arrange the carrier frame on one of the plurality of MEA component sections so that the carrier frame projects beyond the MEA component sections in a direction parallel to the conveying direction of the second vacuum conveyor belt.

8. The apparatus according to claim 5, further comprising a third arranging device configured to arrange a fourth MEA component including an anode or a cathode in the form of a gas diffusion layer, GDL, on one of the plurality of MEA component sections and/or on the third MEA component while the component is being continuously conveyed by the second vacuum conveyor belt or by a third vacuum conveyor belt.

9. The apparatus according to claim 1, wherein the first cutting device is a cutting cylinder.

10. A method of manufacturing a membrane electrode assembly, MEA, comprising:
continuously conveying, with a first vacuum conveyor belt, a first MEA component in the form of a web material at a first conveying speed;
at least partially arranging, with a first arranging device, a second MEA component on the first MEA component while the first MEA component is continuously conveyed by the first vacuum conveyor belt;
cutting, with a first cutting device, the first MEA component with the second MEA component at least partially arranged thereon into a plurality of MEA component sections, so that the MEA component sections each include at least a part of the first and the second MEA components; and
continuously conveying, with a second vacuum conveyor belt, the plurality of MEA component sections at a second conveying speed; wherein the second conveying speed is higher than the first conveying speed.

11. The apparatus according to claim 2, wherein the second MEA component is a catalyst-coated membrane.

12. The apparatus according to claim 3, wherein the individual web material sections are catalyst-coated membrane sections.
